(19) United States
(12) Patent Application Publication
(10) Pub. No.: US 2024/0308868 A1
(43) Pub. Date: Sep. 19, 2024

(54) METHOD AND APPARATUS FOR ALUMINA CALCINATION

(71) Applicant: The University of Adelaide, Adelaide (AU)

(72) Inventors: Woei Lean Saw, Adelaide (AU); Graham Jerold Nathan, Adelaide (AU); Raymond Victor Chatfield, Leeming (AU); Ross Jeffrey Haywood, Cedar Pocket (AU)

(21) Appl. No.: 18/570,800

(22) PCT Filed: Jun. 17, 2022
(86) PCT No.: PCT/AU2022/050615

§ 371 Date: Dec. 15, 2023

(30) Foreign Application Priority Data
Jun. 17, 2021 (AU) 2021901825

(51) Int. Cl. C01F 7/444

(52) U.S. Cl. CPC C01F 7/444

(57) ABSTRACT

An improved apparatus for steam calcining aluminium trihydroxide (Al(OH)₃) to produce alumina (Al₂O₃) is disclosed. The apparatus comprises an Al(OH)₃ preheater configured to heat an Al(OH)₃feedstock by contacting it with steam. The Al(OH)₃ preheater comprises at least one gas solid separator for separating preheated Al(OH)₃ from carrier steam. The apparatus further comprises a calciner configured to accept preheated Al(OH)₃ from the Al(OH)₃ preheater and to produce heated Al₂O₃ by steam calcination. The apparatus also comprises an Al₂O₃ cooler configured to remove heat from the heated Al₂O₃ and produce Al₂O₃ product. The Al₂O₃ cooler comprises at least one gas solid separator. The apparatus further comprises a steam compressor in fluid communication with the Al(OH)₃ preheater, the calciner and the Al₂O₃ cooler and configured to accept and pressurise carrier steam from the Al(OH)₃preheater and to provide pressurised carrier steam to the Al(OH)₃ preheater and pressurised carrier steam the Al₂O₃ cooler to transfer Al(OH)₃ feedstock to and within the Al(OH)₃ preheater, and pressurised carrier steam to transfer preheated Al(OH)₃ from the Al(OH)₃ preheater to the calciner, and to transfer heated Al₂O₃ from the calciner to and within the Al₂O₃ cooler.

### PRIORITY DOCUMENT

The present application claims priority from Australian Provisional Patent Application No. 2021901825 titled “METHOD AND APPARATUS FOR ALUMINA CALCINATION” and filed on 17 Jun. 2021, the content of which is hereby incorporated by reference in its entirety.

### TECHNICAL FIELD

The present disclosure relates to the production of alumina from bauxite.

### BACKGROUND

Alumina (aluminium oxide, Al₂O₃) is an intermediate product in the production of aluminium. Alumina is commonly produced from bauxite using the Bayer process. The final step of the Bayer process is calcination which heats aluminium hydroxide (also known as aluminium trihydroxide, gibbsite or Al(OH)₃) to drive off the water of hydration and form anhydrous alumina. Calcination is commonly carried out in rotary kilns, stationary calciners, such as circulating fluidized bed (CFB), gas suspension (GSC) or fluid flash (FF) calciners.

Calcination is an energy intensive process and the required heat for the calcination of aluminium hydroxide is commonly provided by combustion of a fuel inside a calcination reactor. Recovery of heat energy via recirculation of solids and/or gases is often undertaken to make the process more energy efficient.

Modern plants typically process aluminium hydroxide within stationary calciners using particles of ˜100 μm in diameter transported in a gas suspension through the reactor. In stationary calciners, combustion gases from the furnace section of the calciner mix directly with the hydrated aluminium hydroxide being calcined. After calcination, the gases are separated. The stack gases are a mixture of combustion products and water vapour released as steam from the aluminium hydroxide during calcination. This steam is lost to the atmosphere through the stacks together with its latent heat energy.

A wide range of energy sources have been explored providing the required heat for calciners, including combustion of fuels, electrical resistance heating, hot oil, hot salt, inductance heating, lasers, plasmas, microwave radiation and solar. The combustion of fossil fuels is presently the lowest-cost energy source but it generates CO₂ emissions that are released to the atmosphere. Hence there is a need for a lower-cost, more efficient way to supply the heat without releasing CO₂ to the atmosphere.

U.S. Pat. No. 5,336,480 discloses a calcination process that uses steam in the calciner. Specifically, aluminium hydroxide is heated indirectly in tubes by hot exhaust gases and the generated steam fluidises the particle beds in the tubes. This process requires steam from an auxiliary steam source to fluidise particles in the tubes until self-fluidisation occurs. Published international patent application No. WO 2008/052249 discloses a calcination process that involves contacting aluminium hydroxide in the calciner directly with steam in the calcination process. A difficulty with these processes is that they are carried out under high pressure conditions of 8 bars. Furthermore, there are significant energy losses in these processes as about one third of the steam that is generated from the calcination is lost to the atmosphere.

There is a need for a process for calcining aluminium hydroxide to form alumina that overcomes one or more of the problems associated with prior art processes. Alternatively, or in addition, there is a need for a process for calcining aluminium hydroxide to form alumina that provides an alternative to prior art processes.

### SUMMARY

According to a first aspect, there is provided an apparatus for calcining aluminium trihydroxide (Al(OH)₃) in a steam-rich atmosphere to produce alumina (Al₂O₃), the apparatus comprising:

an Al(OH)₃ preheater configured to heat an Al(OH)₃ feedstock by contacting it with steam, the Al(OH)₃ preheater comprising at least one gas solid separator for separating preheated Al(OH)₃ from carrier steam;

a calciner configured to accept preheated Al(OH)₃ from the Al(OH)₃ preheater and to produce heated Al₂O₃ by steam calcination;

an Al₂O₃ cooler configured to remove heat from the heated Al₂O₃ and produce Al₂O₃ product, the Al₂O₃ cooler comprising at least one gas solid separator;

a steam compressor in fluid communication with the Al(OH)₃ preheater, the calciner and the Al₂O₃ cooler and configured to accept and pressurise the carrier steam from the Al(OH)₃ preheater and to provide pressurised carrier steam to the Al(OH); preheater and the Al₂O₃ cooler to transfer Al(OH)₃ feedstock to and within the Al(OH)₃ preheater, to transfer preheated Al(OH)₃ from the Al(OH)₃ preheater to the calciner, and to transfer heated Al₂O₃ from the calciner to and within the Al₂O₃ cooler.

In some embodiments, the apparatus further comprises a steam heater configured to accept cooled steam from the Al₂O₃ cooler, heat the cooled steam to a temperature of up to 1200° C. and deliver heated steam to the calciner.

In some embodiments, the calciner is configured to be heated by combustion of hydrogen and oxygen gases, by a thermal plasma torch, by high temperature steam, by high temperature particles, by a heat transfer medium, by microwave, by resistive and/or by radiative heating.

In some embodiments, the apparatus further comprises a second steam compressor in fluid communication with the steam compressor and configured to accept excess steam from the steam compressor and to pressurise the excess steam and transfer the pressurised excess steam to the digestion stage of the Bayer alumina process and/or to another application of pressurised steam, thereby recovering the enthalpy that is lost from the current processes.

According to a second aspect, there is provided a process for producing alumina (Al₂O₃) by steam calcination of aluminium trihydroxide (Al(OH)₃), the process comprising:

preheating an Al(OH)₃ feedstock by contacting it with steam in an Al(OH)₃ preheater, the Al(OH)₃ preheater comprising at least one gas solid separator for separating preheated Al(OH)₃ from carrier steam;

treating the preheated Al(OH)₃ from the Al(OH)₃ preheater with steam in a calciner under conditions to produce heated Al₂O₃;

removing heat from the heated Al₂O₃ using an Al₂O₃ cooler to produce Al₂O₃ product, the Al₂O₃ cooler comprising at least one gas solid separator;

transferring carrier steam from the Al(OH)₃ preheater to a steam compressor to pressurise the carrier steam; and

providing pressurised carrier steam from the steam compressor to the Al(OH)₃ preheater and the Al₂O₃ cooler to transfer Al(OH)₃ feedstock to and within the Al(OH)₃ preheater, to transfer preheated Al(OH)₃ from the Al(OH)₃ preheater to the calciner, and to transfer heated Al₂O₃ from the calciner to and within the Al₂O₃ cooler.

In some embodiments, the process further comprises transferring cooled steam from the Al₂O₃cooler to a steam heater, heating the cooled steam to a temperature of up to 1200° C. and transferring the heated steam to the calciner.

In some embodiments, the process further comprises transferring excess steam from the steam compressor to a second steam compressor, pressurising the excess steam and transferring the pressurised excess steam to the digestion stage of the Bayer alumina process and/or to another application for pressurised steam.

Advantageously, the apparatus and processes disclosed herein can be operated at slightly above atmospheric pressure and this overcomes the pressure drop of the system. Furthermore, all of the steam generated from the apparatus and processes disclosed herein can be recovered, thereby making the apparatus and processes more energy efficient than prior art apparatus and processes. Also, no CO₂ is generated from the apparatus and processes disclosed herein.

### BRIEF DESCRIPTION OF THE FIGURES

Embodiments of the present disclosure will be discussed with reference to the accompanying figures wherein:

FIG. 1 is a schematic diagram showing a prior art flash calcination apparatus that uses air as the calcination agent;

FIG. 2 is a schematic diagram showing a steam calciner for co-production of alumina oxide and steam according to an embodiment of the present disclosure;

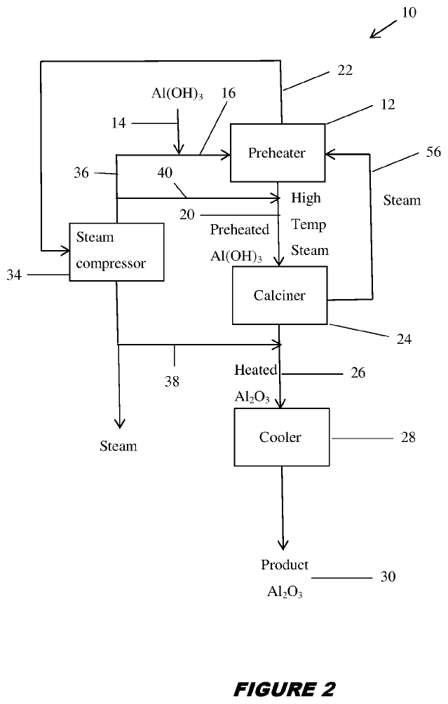

FIG. 3 is a schematic diagram showing a steam calciner for co-production of alumina oxide and steam according to an embodiment of the present disclosure;

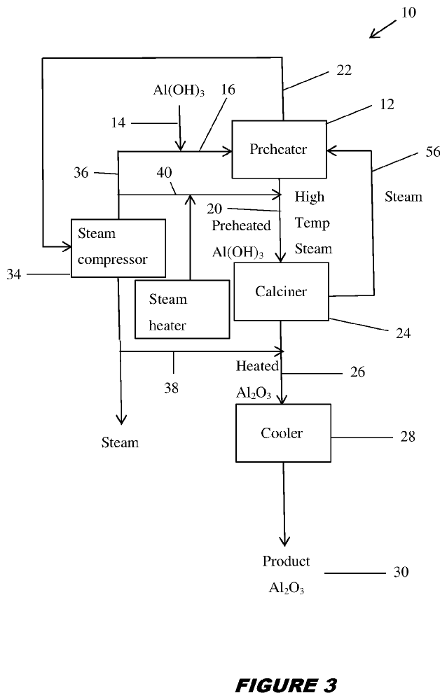

FIG. 4 is a schematic diagram showing a steam flash calciner for co-production of alumina oxide and steam according to another embodiment of the present disclosure;

FIG. 5 is a schematic diagram showing a steam flash calciner for co-production of alumina oxide and steam according to another embodiment of the present disclosure;

FIG. 6 is a schematic diagram showing a steam flash calciner for co-production of alumina oxide and steam according to another embodiment of the present disclosure;

FIG. 7 is a schematic diagram showing a steam gas suspension calciner for co-production of alumina oxide and steam according to another embodiment of the present disclosure;

FIG. 8 is a schematic diagram showing a steam gas suspension calciner for co-production of alumina oxide and steam according to another embodiment of the present disclosure;

FIG. 9 is a schematic diagram showing a steam gas suspension calciner for co-production of alumina oxide and steam according to another embodiment of the present disclosure;

FIG. 10 is a schematic diagram showing a steam circulating fluid bed (CFB) calciner for co-production of alumina oxide and steam according to another embodiment of the present disclosure; and

FIG. 11 is a schematic diagram showing a steam circulating fluid bed (CFB) calciner for co-production of alumina oxide and steam according to another embodiment of the present disclosure.

In the following description, like reference characters designate like or corresponding parts throughout the figures.

### DESCRIPTION OF EMBODIMENTS

Details of terms used herein are given below for the purpose of guiding those of ordinary skill in the art in the practice of the present disclosure. The terminology in this disclosure is understood to be useful for the purpose of providing a better description of particular embodiments and should not be considered limiting.

Unless otherwise explained, all technical and scientific terms used herein have the same meaning as commonly understood by one of ordinary skill in the art to which this disclosure belongs.

In the context of the present disclosure, the terms “about” and “approximately” are used in combination with an amount, number, or value, then that combination describes the recited amount, number, or value alone as well as the amount, number, or value plus or minus 10% of that amount, number, or value. By way of example, the phrases “about 40%” and “approximately 40%” disclose both “40%” and “from 36% to 44%, inclusive”.

The singular terms “a,” “an,” and “the” include plural referents unless context clearly indicates otherwise. The term “comprises” means “includes.” Therefore, comprising “A” or “B” refers to including A, including B, or including both A and B. It is further to be understood that all base sizes or amino acid sizes, and all molecular weight or molecular mass values, given for nucleic acids or polypeptides are approximate, and are provided for description.

Although methods and materials similar or equivalent to those described herein can be used in the practice or testing of the present disclosure, suitable methods and materials are described herein. In case of conflict, the present specification, including explanations of terms, will control. In addition, the materials, methods, and examples are illustrative only and not intended to be limiting.

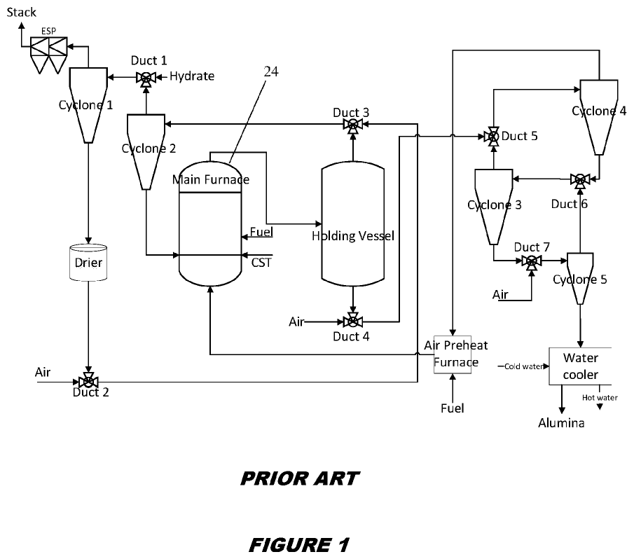

The present disclosure provides an apparatus for calcining aluminium trihydroxide (Al(OH)₃) to produce alumina (Al₂O₃) that improves on known apparatus, such as the one shown in FIG. 1. Briefly, the prior art apparatus shown comprises a calciner 24 in which the heat required to calcine aluminium hydroxide is provided by a fuel and also by heated air. The heated air is provided by a furnace that, in turn, is fuel driven. A problem with this apparatus is that steam that is produced is diluted with nitrogen gas and carbon dioxide gas which means that it cannot be recovered and used in other parts of the Bayer process, such as in the digestion process.

Disclosed herein is an improved apparatus 10 for steam calcining aluminium trihydroxide (Al(OH)₃) to produce alumina (Al₂O₃). The apparatus 10 comprises an Al(OH)₃ preheater 12 configured to heat an Al(OH)₃ feedstock 14 by contacting it with steam 16. The Al(OH)₃ preheater 12 comprises at least one gas solid separator 18 for separating preheated Al(OH)₃ 20 from carrier steam 22. The apparatus 10 further comprises a calciner 24 configured to accept preheated Al(OH)₃ 20 from the Al(OH)₃ preheater 12 and to produce heated Al₂O₃ 26 by steam calcination. The apparatus 10 also comprises an Al₂O₃ cooler 28 configured to remove heat from the heated Al₂O₃ 26 and produce Al₂O₃ product 30. The Al₂O₃ cooler 28 comprises at least one gas solid separator 32. The apparatus further comprises a steam compressor 34 in fluid communication with the Al(OH)₃ preheater 12, the calciner 24 and the Al₂O₃ cooler 28 and configured to accept and pressurise carrier steam 22 from the Al(OH)₃ preheater 12 and to provide pressurised carrier steam 36 to the Al(OH)₃ preheater 12 and pressurised carrier steam 38 to the Al₂O₃ cooler 28 to transfer Al(OH)₃ feedstock 14 to and within the Al(OH)₃ preheater 12, and pressurised carrier steam 40 to transfer preheated Al(OH)₃ 20 from the Al(OH)₃ preheater 12 to the calciner 24, and to transfer heated Al₂O₃ 26 from the calciner 24 to and within the Al₂O₃ cooler 28.

Also disclosed herein is a process for producing alumina (Al₂O₃) by steam calcination of aluminium trihydroxide (Al(OH)₃). The process comprises preheating an Al(OH)₃ feedstock 14 by contacting it with steam 16 in an Al(OH)₃ preheater 12. The Al(OH)₃ preheater 12 comprises at least one gas solid separator 18 for separating preheated Al(OH)₃ 20 from carrier steam 22. The process further comprises treating the preheated Al(OH)₃ 20 from the Al(OH)₃ preheater 12 with steam 16 in a calciner 24 under conditions to produce heated Al₂O₃ 26. The process further comprises removing heat from the heated Al₂O₃ 26 using an Al₂O₃ cooler 28 to produce Al₂O₃ product 30. The Al₂O₃ cooler 28 comprises at least one gas solid separator 32. Carrier steam 22 from the Al(OH)₃ preheater 12 is transferred to a steam compressor 34 to pressurise the carrier steam 22 and pressurised carrier steam 36 is provided from the steam compressor 34 to the Al(OH)₃ preheater 12 and the Al₂O₃ cooler 28 to transfer Al(OH)₃ feedstock 14 to and within the Al(OH)₃ preheater 12, to transfer preheated Al(OH)₃ 20 from the Al(OH)₃ preheater 12 to the calciner 24, and to transfer heated Al₂O₃ 26 from the calciner to and within the Al₂O₃ cooler 28.

In the apparatus and processes disclosed herein, steam is used as the calcination agent to calcine aluminium hydroxide to aluminium oxide at temperatures in the range of 600° C. to 1200° C. Notably, the entire calcination process is performed in a steam rich environment. This allows all of the steam generated from calcination of the aluminium hydroxide to be recovered for use in the digestion stage of the Bayer process, following pressurization using the steam compressor, while the particles are conveyed through the calcination process by recycling some of the outlet gases for re-introduction to various points in the calcination process.

The apparatus 10 can be built de novo. However, the apparatus 10 can also advantageously be readily retrofitted to a current alumina calcination plant. This then allows the risk of demonstration (and hence capital outlay) to be greatly reduced.

The steam used in the apparatus and process contains at least 50% steam, such as 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% steam. The remainder of the stream can be any suitable gas, such as air, nitrogen, etc. In some embodiments, the steam contains greater than 95% steam.

The aluminium trihydroxide (Al(OH)₃) will typically be sourced from the precipitation stage of the Bayer process.

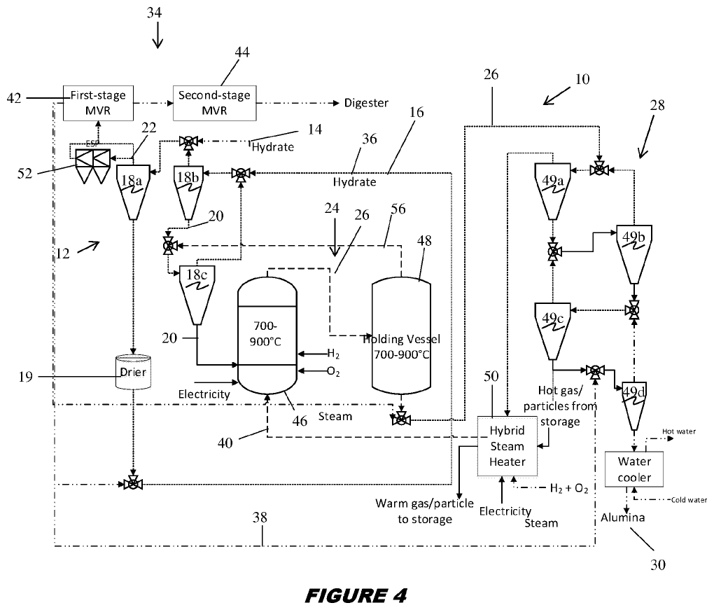

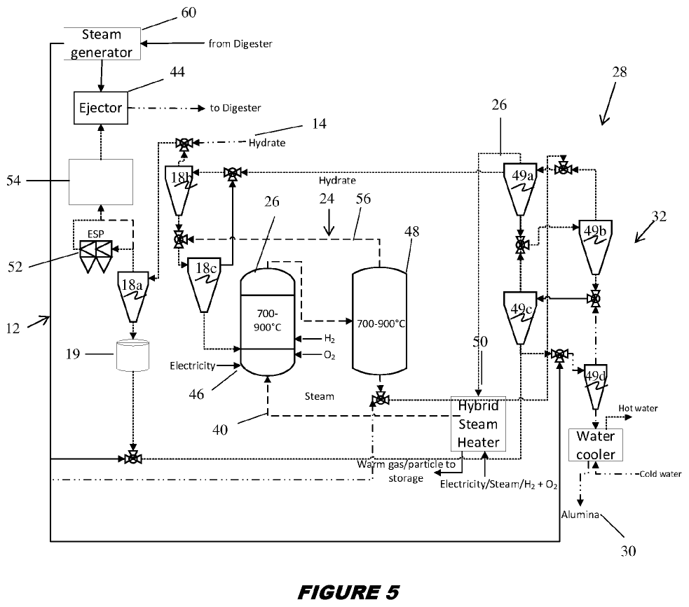

The Al(OH)₃ feedstock 14 that is to be calcined is transferred to the Al(OH)₃ preheater 12 using pressurised carrier steam 36. The Al(OH)₃ is heated in the preheater 12 by contact with steam 16 and steam 56 from the calciner 24. The steam 56 from the calciner 24 has a temperature of from about 600° C. to about 1200° C. and is therefore important in heating the Al(OH)₃. The steam temperature of steam 16 is less than 200° C. Overall, the Al(OH)₃ is heated to a temperature of from about 200° C. to 450° C. in the Al(OH)₃ preheater 12. The Al(OH)₃ preheater 12 comprises at least one gas solid separator 18 for separating preheated Al(OH)₃ 20 from carrier steam 22. The Al(OH)₃ preheater 12 may have from one to six gas/solid separators 18. Different numbers of gas/solid separators can be used with different capital cost and different efficiency. Any gas/solid separator may be used for this purpose such as cyclone separators, inertial separators, electrostatic separators, filters or baghouse collectors. Cyclone separators are particularly suitable for this purpose and are shown in the illustrated embodiments, where FIGS. 4 and 5 show an Al(OH)₃ preheater 12 that comprises three cyclone gas solid separators 18.

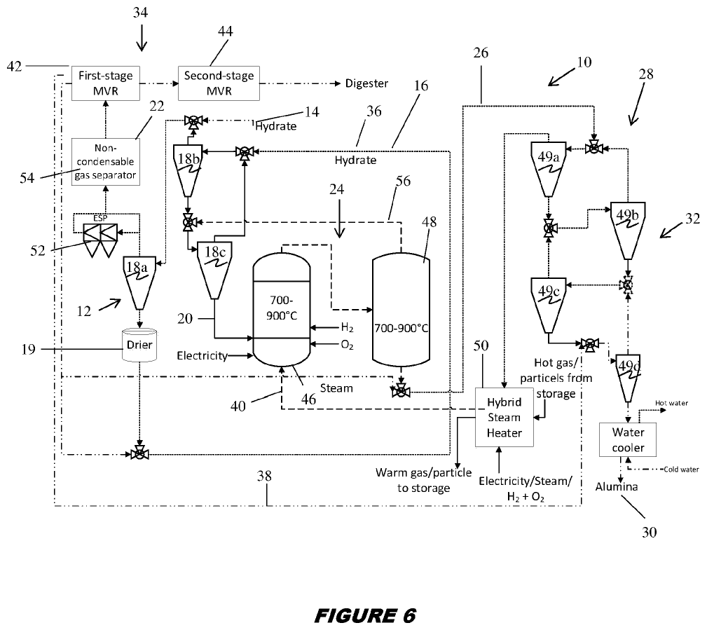

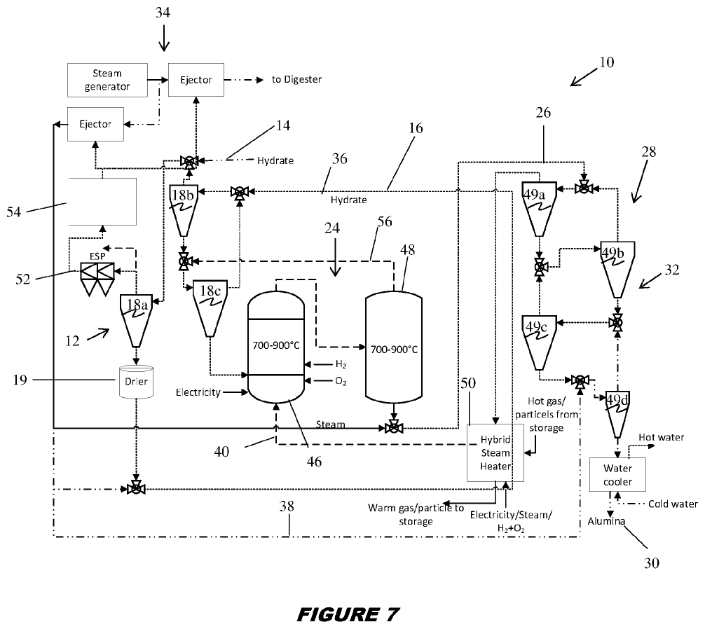

In the embodiments illustrated in FIGS. 4, 5, 6 and 7 Al(OH)₃ feedstock 14 is fed into cyclone 1 18a along with steam from cyclone 2 18b. The steam from cyclone 2 18b is used to heat the particles, thereby removing physical water from the incoming aluminium hydroxide. The steam from cyclone 1 18a is fed to the steam compressor 34 which, in the embodiment shown in FIG. 4, comprises a first stage mechanical vapour recompression (MVR) 42 and a second stage MVR 44 (discussed later). In the embodiment illustrated in FIG. 5 the first stage MVR 42 is a non-condensable gas separator and the second stage MVR 44 is an ejector. Preheated Al(OH)₃ 20 from cyclone 1 18a passes through a drier 19 and is returned to cyclone 2 18b. Preheated Al(OH)₃ 20 from cyclone 2 18b is fed to cyclone 3 18c. Steam from cyclone 3 18c is re-circulated to cyclone 2 18b and preheated Al(OH)₃ 20 from cyclone 3 18c is fed to the calciner 24.

The calciner 24 can be any suitable calciner known in the art, including but not limited to a flash (FF) calciner, a gas suspension calciner (GSC) or a and circulating fluid bed (CFB) calciner. A range of suitable calciners are commercially available.

The calciner 24 accepts preheated Al(OH)₃ 20 from the Al(OH)₃ preheater 12 and produces heated Al₂O₃ 26 by steam calcination. The calciner 24 comprises a calcining chamber 46. The calcining chamber 46 is a hybrid calciner with steam providing some of the energy required for the calcination process in addition to a second energy source. The second energy source can be provided from a wide range of energy sources including electrical heating (e.g. by thermal plasma, microwave, radiative or resistive heating), combustion of hydrogen or oxygen, high temperature particles, high temperature liquid, heat transfer medium or concentrated solar thermal energy. The calcining chamber 46 may be heated directly and/or indirectly. Direct heating may be by combustion of H₂ and O₂, thermal plasma torch or high temperature steam from a steam heater. Indirect heating may be by resistive heating through heaters embedded in, or surrounding, walls of the reactors or pipes, a heat transfer medium (either high temperature air or solids), microwave and/or radiative heating. In the embodiments illustrated in FIGS. 4, 5, 6 and 7, the calcining chamber 46 uses electrical energy and hydrogen combustion.

Calcination occurs in the calcining chamber 46 at temperatures in the range of about 600° C. to about 1200° C., such as about 600°° C., about 700°° C., about 800° C., about 900° C., about 1000° C., about 1100° C. or about 1200° C. Particularly suitable calcination temperatures are from about 700° C. to about 900° C., such as about 600° C., about 700° C., about 800° C. or about 900° C.

Heated Al₂O₃ 26 from the calcining chamber 46 is then fed to a holding vessel 48 where the temperature of the heated Al₂O₃ 26 is maintained in the range of about 600° C. to about 1200° C. such as from about 700°° C. to about 900° C. for a period of time. The capacity of the holding vessel 48 is such that the residence time of the heated Al₂O₃ 26 in the vessel is from a few minutes to 240 minutes. The holding vessel 48 is used to remove residual chemical water from the Al₂O₃ and/or control the phase of the Al₂O₃.

In the embodiments illustrated in FIGS. 4,5, 6 and 7, heated Al₂O₃ 26 particles from the holding vessel 48 are used to pre-heat the incoming steam to cyclone 4 49a, cyclone 5 49b, cyclone 6 49c and 7 49d. Steam from the holding vessel 48 is used to pre-heat and/or pre-calcine incoming Al(OH)₃ particles in cyclone 2 18 b and cyclone 3 18c.

Heated Al₂O₃ 26 from the calciner 24 is fed to Al₂O₃ cooler 28 which is configured to remove heat from the heated Al₂O₃ 26 and produce Al₂O₃ product 30. The Al₂O₃ cooler 28 comprises at least one gas solid separator 32 for separating Al₂O₃ product 30 from steam. The Al₂O₃ cooler 28 may have from one to six gas/solid separators. Different numbers of gas/solid separators can be used with different capital cost and different efficiency. Any gas/solid separator may be used for this purpose such as cyclone separators, inertial separators, electrostatic separators, filters or baghouse collectors. Cyclone separators are particularly suitable for this purpose and are shown in the illustrated embodiments, where FIGS. 4, 5, 6 and 7 show an Al₂O₃ cooler 28 that comprises four cyclones 49a, 49b, 49c and 49d.

In the embodiments illustrated in FIGS. 4, 5, 6 and 7, heated Al₂O₃ 26 is transferred from the holding vessel 48 to cyclone 4 49a. Al₂O₃ from cyclone 4 49a is fed to cyclone 5 49b, Al₂O₃ from cyclone 5 49b is fed to cyclone 6 49c, and Al₂O₃ from cyclone 6 49c is fed to cyclone 7 49d. Al₂O₃ from cyclone 7 49d passes through a water cooler to provide Al₂O₃ product 30.

Heated Al₂O₃ 26 is transferred from the holding vessel 48 to cyclone 4 49a using steam from cyclone 5 49b. Cyclone 5 49b is fed with steam from cyclone 6 49c. Al₂O₃ from cyclone 5 49b is fed to cyclone 6 49c using steam from cyclone 7 49d. Steam from cyclone 4 49a is heated using steam heater 50 which, in turn, supplies heated steam to the calcining chamber 46.

The apparatus 10 further comprises a steam compressor 34 in fluid communication with the Al(OH)₃ preheater 12, the calciner 24 and the Al₂O₃ cooler 28 and configured to accept and pressurise carrier steam 22 from the Al(OH)₃ preheater 12 and to provide pressurised carrier steam 36 to the Al(OH)₃ preheater 12 and pressurised carrier steam 38 to the Al₂O₃ cooler 28 to transfer Al(OH)₃feedstock 14 to and within the Al(OH)₃ preheater 12, and pressurised carrier steam 40 to transfer preheated Al(OH)₃ 20 from the Al(OH)₃ preheater 12 to the calciner 24, and to transfer heated Al₂O₃ 26 from the calciner 24 to and within the Al₂O₃ cooler 28. Thus, in practice the outlet from the last cyclone used to recover heat from the carrier gas stream (which is the exhaust gas for a conventional calciner) is sent to the steam compressor 34 which then feeds it back into the circuit. In the embodiments illustrated in FIGS. 4, 5, 6 and 7, steam from cyclone 1 18a passes to the steam compressor 34 which then feeds pressurised inlet stream which is used to transport the particles to cyclone 2 18b, cyclone 4 49a and 7 49d.

The steam compressor 34 can be any device or apparatus that can pressurise a gas such as steam to a desired pressure that is sufficient to compensate for the total pressure drop across the calcination apparatus 10 or process. For example, a mechanical vapour recompression system (MVR) is particularly suitable. A typical MVR can provide a compression ratio of up to 1.8 and it may be necessary for the steam compressor 34 to comprise more than one MVR in series so as to provide sufficient steam pressure to compensate for pressure drops across the apparatus 10 and process. Therefore, the steam compressor 34 may be a multi-stage steam compressor comprising a primary compressor, a secondary compressor, etc. Another device that could be used is a thermocompressor, which uses high temperature and pressure steam (from a steam generator 60) to increase the temperature of the steam generated from the calciner. Again, more than one thermocompressor may be used in series so as to provide sufficient steam pressure to compensate for pressure drops across the apparatus and process. The steam generator 60 can also be provided from a wide range of alternative energy sources to provide a wide range of options, increasing the relevance to different locations. These include electrical heating (e.g. by thermal plasma, microwave, radiative or resistive heating), combustion of hydrogen and oxygen/air, or concentrated solar thermal energy.

In addition to a first stage steam compressor 42 which may be a multi-stage compressor, the steam compressor 34 may comprise a second steam compressor 44 in fluid communication with the first steam compressor 42 and configured to accept excess steam from the first steam compressor 42 and to pressurise the excess steam and transfer the pressurised excess steam to the digestion stage of the Bayer alumina process and/or to any other application for pressurised steam. This steam recovery process can potentially provide 10-30% energy saving in the digestion process. Typically, steam at a pressure of 8-10 bar is required for the digestion stage of the Bayer process and, therefore, the second steam compressor 44 may also be a multi-stage steam compressor comprising a primary compressor, a secondary compressor, etc. to enable pressurised excess steam of 8-10 bar to be transferred to the digestion stage of the Bayer alumina process.

As shown in FIGS. 4 and 5, a particle filter 52 can be used to remove any residual particles before compression in the steam compressor 34. Any known particle filter can be used for this purpose. Optionally, the apparatus may comprise a bypass of the particle filter 52.

As shown in FIGS. 5, 6 and 7, a gas separator 54 can be used to remove any non-condensable gases from the steam. Any known gas separator can be used for this purpose. Whilst this separator is shown here as being positioned before the first stage of compression, it should be understood to those skilled in the art that it can alternatively be positioned at other positions within the steam cycle, depending on the temperatures and pressures, to remove the non-condensable gases. It will also be appreciated that more than one gas separator 54 could be used in the apparatus or process.

The apparatus 10 may comprise a steam heater 50 configured to accept cooled steam from the Al₂O₃ cooler 28, heat the cooled steam to a temperature of up to 1200° C. and deliver heated steam to the calciner 24. The energy to the steam heater 50 can be provided from a wide range of alternative energy sources to provide a wide range of options, increasing the relevance to different locations. These include electrical heating (e.g. by thermal plasma, microwave, radiative or resistive heating), combustion of hydrogen and oxygen, or concentrated solar thermal energy. In the embodiments illustrated in FIGS. 4, 5, 6 and 7, the steam heater 50 pre-heats the incoming steam from cyclone 4 49a to temperatures of up to 1200° C.

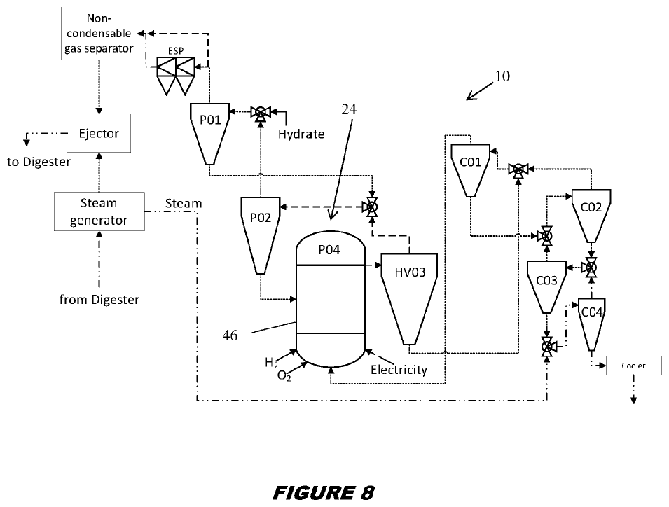

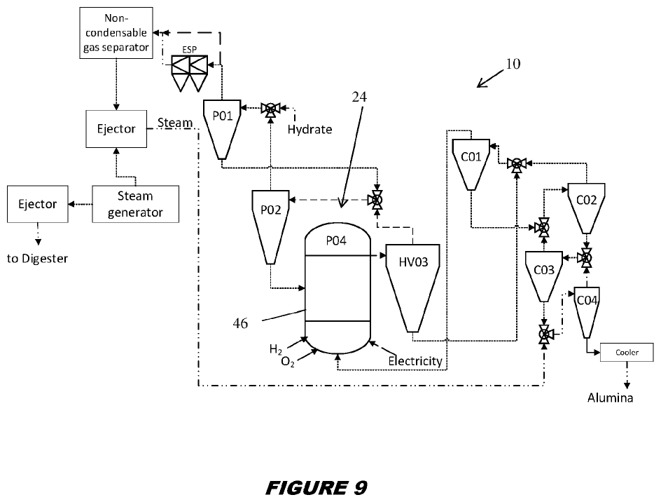

Illustrated in FIGS. 8 and 9 is a calcination apparatus 10 that employs a gas suspension calciner 24. The general configuration of these embodiments is as described in relation to FIGS. 4, 5, 6 and 7.

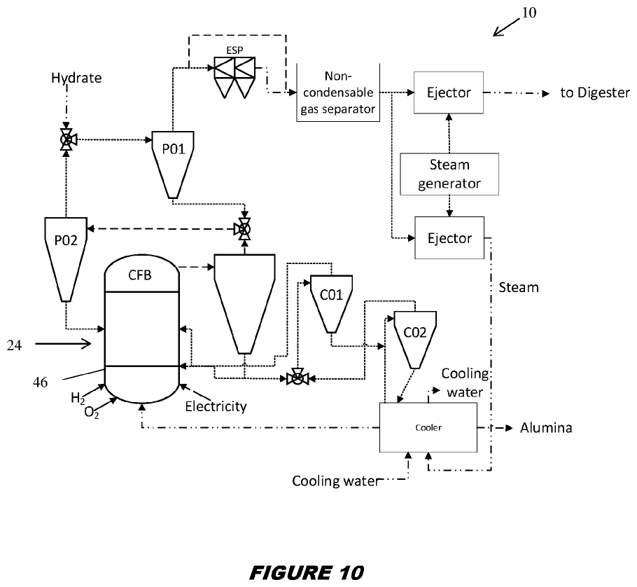

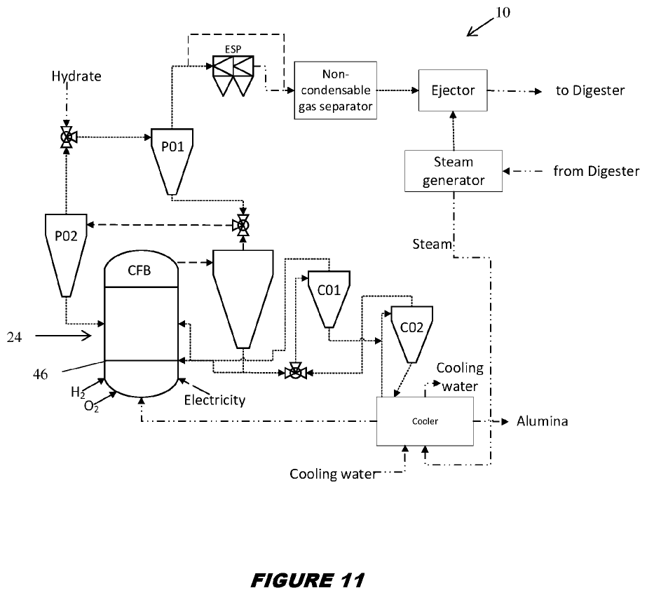

Illustrated in FIGS. 10 and 11 is a calcination apparatus 10 that employs a circulating fluid bed (CFB) calciner 24. The general configuration of these embodiments is as described in relation to FIGS. 4, 5, 6 and 7.

Advantageously, the Al₂O₃ generated from the steam calcination has demonstrated to have the surface area of at least 40% higher than that of smelter grade alumina (SGA). Furthermore, the pore size is at least 3 times larger under steam than the SGA (10 nm vs 3 nm). The increase in surface area and pore size can increase the scrubbing efficiency of hydrogen fluoride (HF) during the aluminium smelting process and hence minimising the HF emission and cryolite consumption.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

It is appreciated that certain features, which are, for clarity, described in the context of separate embodiments, may also be provided in combination in a single embodiment. Conversely, various features which are, for brevity, described in the context of a single embodiment may also be provided separately or in any suitable sub-combination. For example, it will be appreciated that all of the features set out in any of the claims (whether independent or dependent) can be combined in any given way.

As used herein, a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. An apparatus for calcining aluminium trihydroxide (Al(OH)₃) in a steam-rich atmosphere to produce alumina (Al₂O₃), the apparatus comprising:
an Al(OH)₃ preheater configured to heat an Al(OH)₃ feedstock by contacting it with steam, the Al(OH)₃ preheater comprising at least one gas solid separator for separating preheated Al(OH)₃ from carrier steam;
a calciner configured to accept preheated Al(OH)₃ from the Al(OH)₃ preheater and to produce heated Al₂O₃ by steam calcination;
an Al₂O₃ cooler configured to remove heat from the heated Al₂O₃ and produce Al₂O₃product, the Al₂O₃ cooler comprising at least one gas solid separator;
a steam compressor in fluid communication with the Al(OH)₃ preheater, the calciner and the Al₂O₃ cooler and configured to accept and pressurise carrier steam from the Al(OH)₃preheater and to provide pressurised carrier steam to the Al(OH)₃ preheater and the Al₂O₃cooler to transfer Al(OH)₃ feedstock to and within the Al(OH)₃ preheater, to transfer preheated Al(OH)₃ from the Al(OH)₃ preheater to the calciner, and to transfer heated Al₂O₃ from the calciner to and within the Al₂O₃ cooler.

2. The apparatus according to claim 1, further comprising a steam heater configured to accept cooled steam from the Al₂O₃ cooler, to heat the cooled steam to a temperature of up to 1200° C. and to deliver heated steam to the calciner.

3. The apparatus according to claim 1 any one of the preceding claims, wherein the calciner comprises a calcining chamber capable of heating Al(OH)₃ to a temperature of between about 600° C. and about 1200°° C. to produce heated Al₂O₃.

4. The apparatus according to claim 3, wherein the calciner is configured to be heated by combustion of hydrogen and oxygen gases, by a thermal plasma torch, by high temperature steam, by high temperature particles, by a heat transfer medium, by microwave, by resistive and/or by radiative heating.

5. The apparatus according to claim 3, wherein the calciner further comprises a holding vessel configured to accept heated Al₂O₃ from the calcining chamber and maintain the heated Al₂O₃ at a temperature of between about 600° C. and about 1200° C.

6. The apparatus according to claim 5, wherein the holding vessel has a holding capacity to allow a residence time for heated Al₂O₃ of from about 1 minute to about 240 minutes.

7. The apparatus according to claim 5, wherein heated Al₂O₃ from the holding vessel is used to pre-heat pressurised carrier steam provided to the Al₂O₃ cooler.

8. The apparatus according to claim 5, wherein heated Al₂O₃ from the holding vessel is used to pre-heat Al(OH)₃ feedstock provided to the Al(OH)₃ preheater.

9. The apparatus according to claim 1, further comprising a second steam compressor in fluid communication with the steam compressor and configured to accept excess steam from the steam compressor and to pressurise the excess steam and transfer the pressurised excess steam to the digestion stage of the Bayer alumina process and/or to another application for pressurised steam.

10. The apparatus according to claim 1, wherein the Al(OH)₃ preheater comprises from one to six gas/solid separators.

11. The apparatus according to claim 10, wherein the or each gas/solid separator is a cyclone separator.

12. The apparatus according to claim 1, wherein the Al₂O₃ cooler comprises from one to six gas/solid separators.

13. The apparatus according to claim 12, wherein the or each gas/solid separator is a cyclone separator.

14. A process for producing alumina (Al₂O₃) by steam calcination of aluminium trihydroxide (Al(OH)₃), the process comprising:
preheating an Al(OH)₃ feedstock by contacting it with steam in an Al(OH)₃ preheater, the Al(OH)₃ preheater comprising at least one gas solid separator for separating preheated Al(OH)₃from carrier steam;
treating the preheated AI(OH)₃ from the Al(OH)₃ preheater with steam in a calciner under conditions to produce heated Al₂O₃;
removing heat from the heated Al₂O₃ using an Al₂O₃ cooler to produce Al₂O₃ product, the Al₂O₃ cooler comprising at least one gas solid separator;
transferring carrier steam from the Al(OH)₃ preheater to a steam compressor to pressurise the carrier steam; and
providing pressurised carrier steam from the steam compressor to the Al(OH)₃ preheater and the Al₂O₃ cooler to transfer Al(OH)₃ feedstock to and within the Al(OH)₃ preheater, to transfer preheated Al(OH)₃ from the Al(OH)₃ preheater to the calciner, and to transfer heated Al₂O₃ from the calciner to and within the Al₂O₃ cooler.

15. The process according to claim 14, wherein the gaseous atmosphere comprises at least 50% steam.

16. The process according to claim 15, wherein the gaseous atmosphere comprises at least 95% steam.

17. The process according to claim 14, further comprising transferring cooled steam from the Al₂O₃ cooler to a steam heater, heating the cooled steam to a temperature of up to 1200° C. and transferring the heated steam to the calciner.

18. The process according to claim 14, comprising heating the Al(OH)₃ to a temperature of between about 600° C. and about 1200° C. to produce heated Al₂O₃.

19. The process according to claim 14, further comprising transferring heated Al₂O₃ from the calciner to a holding vessel configured to accept heated Al₂O₃ and maintaining the heated Al₂O₃ at a temperature of between about 600° C. and about 1200° C.

20. The process according to claim 19, comprising holding the heated Al₂O₃in the holding vessel for a period of from about 1 minute to about 240 minutes.

21. The process according to claim 19, comprising pre-heating pressurised carrier steam provided to the Al₂O₃ cooler using heat from the heated Al₂O₃ in the holding vessel.

22. The process according to claim 19, comprising pre-heating Al(OH)₃ feedstock provided to the Al(OH)₃ preheater using heat from the heated Al₂O₃ in the holding vessel.

23. The process according to claim 14, further comprising transferring excess steam from the steam compressor to a second steam compressor, pressurising the excess steam and transferring the pressurised excess steam to the digestion stage of the Bayer alumina process and/or to another application for pressurised steam.
